(19) United States
(12) Patent Application Publication
(10) Pub. No.: US 2006/0224289 A1
(43) Pub. Date: Oct. 5, 2006

(54) Pedestrian detection system

(75) Inventors: Shinichi Kiribayashi, Anjo-city (JP); Hisashi Takahashi, Kariya-city (JP); Sadayuki Kuwahara, Bisai-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/388,065

(22) Filed: Mar. 23, 2006

(30) Foreign Application Priority Data
Mar. 29, 2005 (JP) 2005-094619
Feb. 28, 2006 (JP) 2006-052233

(51) Int. Cl. B60R 22/00

(52) U.S. Cl. 701/45; 701/301

(57) ABSTRACT

A pedestrian detection system for a vehicle includes multiple acceleration sensors provided at different positions in a periphery portion of the vehicle, and a calculation unit for performing, based on a signal outputted by a designation acceleration sensor belonging to the multiple acceleration sensors, a determination whether an object colliding with the vehicle is a pedestrian. The designation acceleration sensor is one of the multiple acceleration sensors other than a closest acceleration sensor which is closest of the multiple acceleration sensors to a collision point with which the object has collided.

### CROSS REFERENCE TO RELATED APPLICATION

This application is based on and incorporates herein by reference Japanese patent applications No. 2005-94619 filed on Mar. 29, 2005, and No. 2006-52233 filed on Feb. 28, 2006.

### FIELD OF THE INVENTION

The present invention relates to a pedestrian detection system for detecting a collision of a pedestrian with a vehicle.

### BACKGROUND OF THE INVENTION

Recently, efforts have been made to develop a technology to ensure safety of a human in a vehicle accident. In particular, it is required to protect a pedestrian from a fatal damage when he/she collides with the vehicle, as well as to ensure safety of an occupant in the vehicle.

It has been considered, as a method to protect the pedestrian colliding with the vehicle, to reduce an injury level (i.e. a strength of an impact caused by a collision) which is given to the pedestrian who collides with the vehicle and then falls on a hood of the vehicle. By reducing the injury level, the pedestrian is possibly protected from the fatal damage.

For example, a pedestrian protection system disclosed in US 6516278-B1 (JP 2001-80545A) lifts up the hood when the pedestrian collides with a bumper of the vehicle, so that the hood cushions a secondary impact between the vehicle and the pedestrian. In a typical collision of the pedestrian with the running vehicle, the pedestrian is thrown upward by the vehicle and then collide secondarily with the hood of the vehicle. The hood is lifted up at this moment and thereby is deformed so as to cushion the secondary impact. The injury level which the pedestrian suffers through the secondary impact is thus reduced.

The pedestrian protection system in US 6516278-B1 detects the collision of the pedestrian based on a change of an acceleration applied to the bumper in the moment of the collision. Although the change of the acceleration indicates that someone or something has collided with the bumper, it is difficult to determine based on the change whether an object which has collided with the bumper is a human body. The pedestrian protection system may cause a trouble in driving the vehicle if it erroneously determines that the pedestrian has collided with the bumper based on the change of the acceleration caused by a collision of the bumper with a standing pavement marker or a pylon.

### SUMMARY OF THE INVENTION

It is therefore an object of the present invention to provide a pedestrian detection system for a vehicle, which is capable of determining whether or not an object which has collided with the vehicle is a pedestrian (person).

A pedestrian detection system for a vehicle includes multiple acceleration sensors provided at different positions in a periphery portion of the vehicle, and a calculation unit for performing, based on a signal outputted by a designation acceleration sensor belonging to the multiple acceleration sensors, a determination whether an object colliding with the vehicle is a pedestrian. The designation acceleration sensor is one of the multiple acceleration sensors other than a closest acceleration sensor which is closest of the multiple acceleration sensors to a collision portion with which the object has collided.

When an impact of a collision of the object with the collision portion propagates from the collision portion to the location of the designated acceleration sensor, sensitivity of an intensity of the impact to a kind of the object is enhanced. The pedestrian detection system can therefore detect with a high accuracy that the pedestrian collides with the vehicle.

For example, the designation acceleration sensor is one of the multiple acceleration sensors adjacent to the closest acceleration sensor. The calculation unit can detect the collision portion based on comparison between signals outputted from the multiple acceleration sensors, or detect the collision portion using a signal from the touch sensor. Furthermore, the multiple acceleration sensors can be provided at a center portion and two end portions of a bumper of the vehicle.

The calculation unit can perform the determination whether the object colliding with the vehicle is the pedestrian by using a speed of the vehicle. Further, the calculation unit can determine that the object colliding with the vehicle is the pedestrian, when a representative quantity of deceleration detected by the designation sensor is larger than a threshold. In addition, the calculation unit can change the threshold based on a speed of the vehicle, and the representative quantity may be a time integral of the deceleration detected by the designation sensor.

Furthermore, the calculation unit can determines the collision portion based on comparison of a threshold with each of signals outputted by the multiple acceleration sensors.

Generally, the vehicle includes a bumper having a reinforcement and a pair of side members. The reinforcement extends in a width direction of the vehicle, the side members is attached to respective end portions of the reinforcement, and the side members support the reinforcement. In this case, the acceleration sensors can be attached to a center portion of the reinforcement in the width direction and a position between the center portion and at least one of the side members.

### BRIEF DESCRIPTION OF THE DRAWINGS

The invention, together with additional objective, features and advantages thereof, will be best understood from the following description, the appended claims and the accompanying drawings. In the drawings:

FIG. 1 is a schematic view of a pedestrian detection system for a vehicle according to a first embodiment of the present invention;

FIG. 2 is an enlarged view of a portion of the pedestrian detection system in a vicinity of a bumper of the vehicle;

FIG. 3 is a flowchart showing a process for determination as to whether a collision with a pedestrian is caused;

FIGS. 4 to 6 are time charts showing experimentally measured changes in accelerations applied to the bumper at the moment of the collision;

FIG. 7 is a schematic view of a pedestrian detection system for a vehicle according to a second embodiment of the present invention;

FIG. 8 is an enlarged view of a portion of the pedestrian detection system at a vicinity of a bumper of the vehicle;

FIG. 9 is a schematic view of a pedestrian detection system for a vehicle according to a third embodiment of the present invention;

FIG. 10 is a schematic view of a pedestrian detection system for a vehicle according to a fourth embodiment of the present invention;

FIG. 11 is an enlarged view of a portion of a pedestrian detection system according to a fifth embodiment of the present invention; and

FIG. 12 is a determination map used to determine a collision position in the fifth embodiment.

### DETAILED DESCRIPTION OF THE EMBODIMENTS

(First Embodiment)

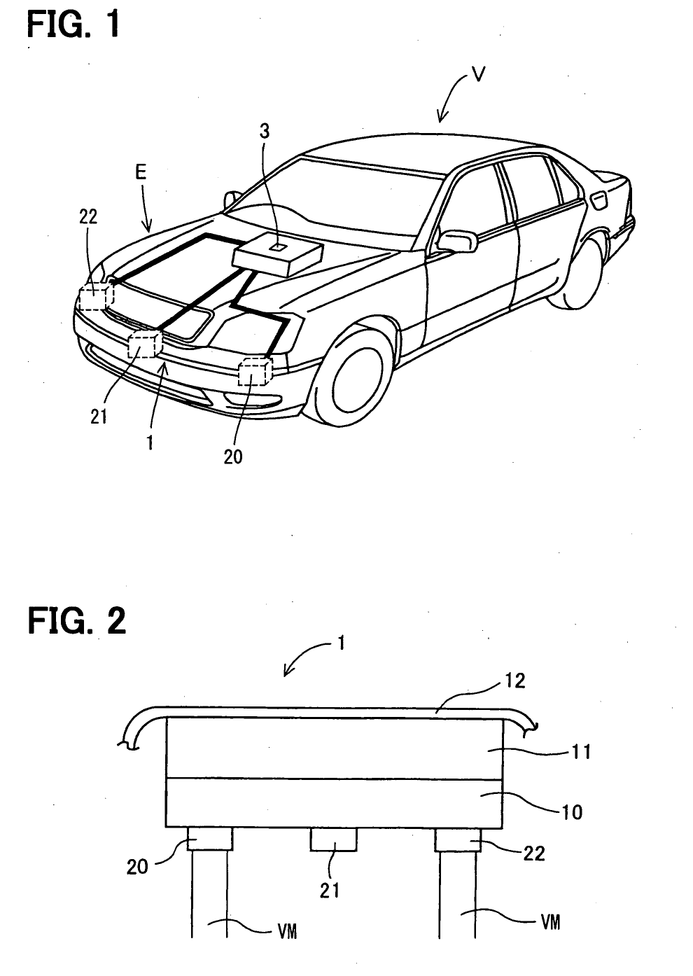

As shown in FIG. 1, a pedestrian detection system for a vehicle V includes a calculation unit 3 and acceleration sensors 20, 21 and 22. The acceleration sensors 20, 21 and 22 are attached to a bumper 1 of the vehicle V.

The vehicle V includes an engine room E in front of a passenger compartment of the vehicle V. However, the vehicle V, in which the pedestrian detection system is installed, is not limited to include the engine room E, and may be any kind of vehicle having the bumper 1.

As shown in FIG. 2, the bumper 1 in front of the engine room E includes a bumper reinforcement 10, an absorber 11 located at a front side of the bumper reinforcement 10, and a bumper cover 12 at a front side of the absorber 11. The bumper reinforcement 10 is fixed to the vehicle V through front side members VM located at a front left corner and a front right corner of the vehicle V. The absorber 11 is made of an elastic material such as resin foam and reduces an impact to be applied to a front side of the bumper reinforcement 10.

The acceleration sensors 20, 21 and 22 are attached at different portions to a rear side of the bumper reinforcement 10. More specifically, the acceleration sensor 21 is located at the center in the width direction of the bumper reinforcement 10. Each of the acceleration sensors 20 and 22 is located at a position where the bumper reinforcement 10 and the one of the front side members VM are fixed together. In other words, the acceleration sensors 20 and 22 are located at or close to the two ends of the bumper 1.

The calculation unit 3 is electrically connected with the acceleration sensors 20, 21 and 22 in parallel, and performs a determination regarding a collision based on signals from the acceleration sensors 20, 21 and 22.

The calculation unit 3 is constructed as a single member together with an ECU which controls an air bag and thereby serves as an occupant protection unit. The calculation unit 3 operates as a pedestrian protection part for protecting a pedestrian when it performs a determination that the pedestrian has collided with the vehicle V.

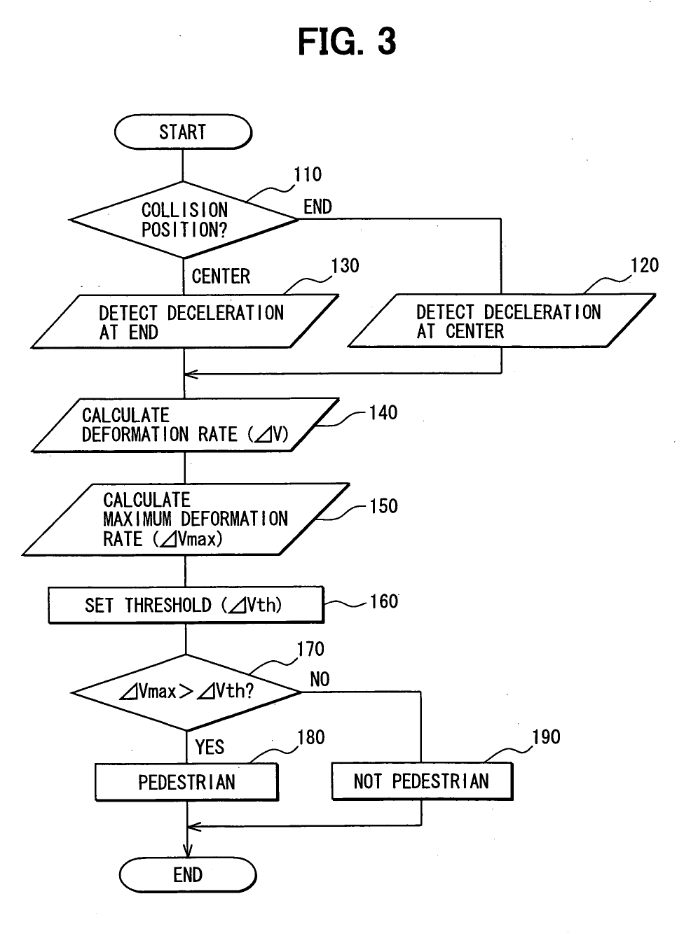

Hereafter, a description will be given, with reference to the flowchart in FIG. 3, of an operation of the pedestrian detection system including the determination regarding to the collision in the case that an object collides with the vehicle V.

When an object collides with the bumper 1 of the running vehicle V, the bumper 1 receives acceleration in a direction toward the rear side of the vehicle V. The acceleration sensors 20, 21 and 22 detect a variation in the acceleration and output signals depending on the detected variation. The calculation unit 3 detects, at a step 110 based on the three signals from the acceleration sensors 20, 21 and 22, a collision position of the bumper 1 with which the object has collided. For example, the calculation unit 3 determines that a collision position of the object is at a vicinity of one sensor (closest sensor) which has outputted a signal with the highest intensity among the acceleration sensors 20, 21 and 22.

Then the calculation unit 3 starts a collision object determination for determining whether or not the object is a body of a pedestrian based on a signal outputted by an adjacent sensor. The adjacent sensor is one of the acceleration sensors 20, 21 and 22, which is adjacent to the closest sensor. More specifically, the acceleration sensor 21 is determined at a step 120 to be the adjacent sensor when the acceleration sensor 20 or 22 is determined at the step 110 to be the closest sensor. One of the acceleration sensors 20 and 22 is determined at a step 130 to be the adjacent sensors when the calculation unit 3 determines at the step 110 that the acceleration sensor 21 is the closest sensor and the one of the acceleration sensors 20 and 22 is closer to the collision position than the other of the acceleration sensors 20 and 22.

In the collision object determination, the calculation unit 3 calculates, based on the signals from the acceleration sensors 20, 21 and 22, a deceleration (i.e. inverse of an acceleration) G of the bumper 1 (the step 120 or 130), a deformation rate ΔV of the bumper 1 (a step 140), and a maximum deformation rate ΔVmax of the bumper 1 (a step 150). The deformation rate ΔV can be obtained by integrating the calculated deceleration G by a time.

Then, the calculation unit 3 compares at a step 170 the maximum deformation rate ΔVmax with a predetermined threshold ΔVth set at a step 160. The predetermined threshold ΔVth may be determined when the pedestrian detection system is installed in the vehicle V. The calculation unit 3 determines at a step 180 that the object is the body of the pedestrian when the maximum deformation rate ΔVmax is larger than the predetermined threshold ΔVth. In contrast, the calculation unit 3 determines at a step 190 that the object is something other than the body of the pedestrian when the maximum deformation rate ΔVmax is not larger than the predetermined threshold ΔVth.

When the calculation unit 3 determines that the object is the body of the pedestrian, it activates the pedestrian protection system. The pedestrian is thus protected.

The pedestrian detection system has an advantage in accuracy of determining whether or not the object colliding with the vehicle V is the pedestrian, and therefore suppresses an occurrence of a trouble caused by erroneously determining that the pedestrian has collided with the vehicle V.

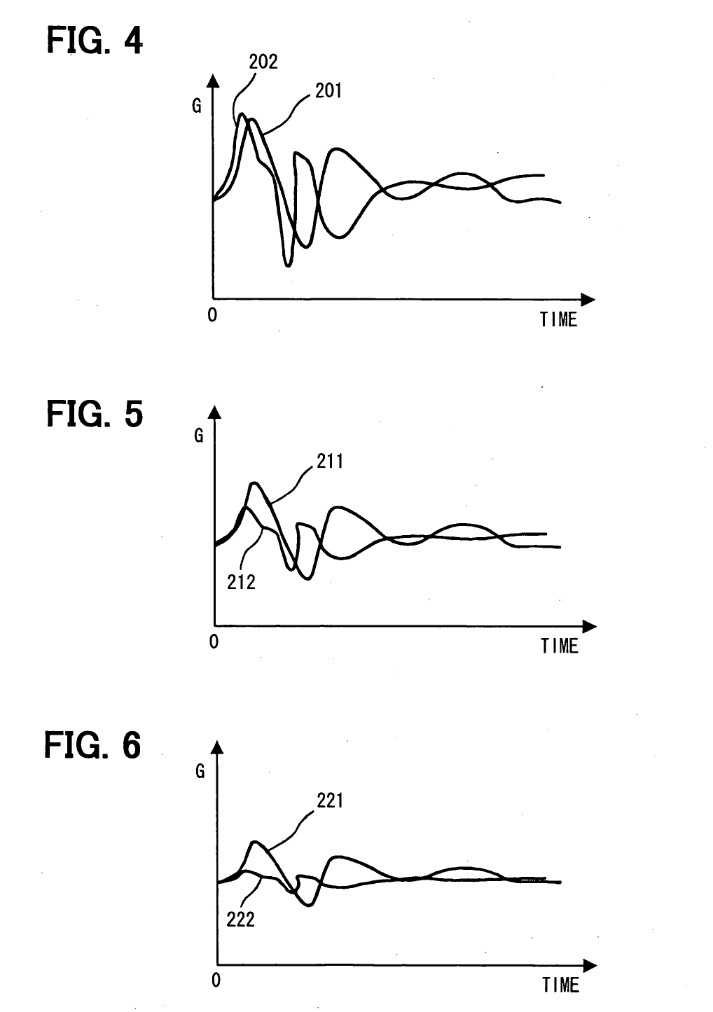

The time charts in FIGS. 4, 5 and 6 show accelerations (deceleration G) measured respectively by the acceleration sensors 20, 21, and 22, in experimental situations where a test object collides with an end portion of the bumper 1 closer to the front passenger seat (i.e., the seat next to the driver seat) of the vehicle V (that is, an end portion of the bumper 1 closer to the acceleration sensor 20). Solid lines 201, 211 and 221 show the detected accelerations in the situation where the test object is a dummy doll mimicking a baby under the age of six and collides with the vehicle V at a speed of 25 Km/h. Solid lines 202, 212 and 222 show the detected accelerations in the situation where the test object is a standing pavement marker or a pylon and collides with the vehicle V at a speed of 40 Km/h. At the origin of the graphs where the time is set to be zero, the test object makes a collision with the vehicle V.

As shown in FIG. 4, the accelerations 201 and 202 detected by the acceleration sensor 20 in above two situations have similar variations for a time. In contrast, as shown in FIG. 5, the accelerations 211 and 212 detected by the acceleration sensor 21 in the two situations have relatively different variations for the time time. In addition, as shown in FIG. 6, the accelerations 221 and 222 detected by the acceleration sensor 22 in the two situations have more notably different variations for the time. This implies that the impact of the collision has been damped through a propagation path to the acceleration sensor 22.

As described above, the pedestrian detection system determines whether the object colliding with the vehicle V is the pedestrian, based on a signal from an acceleration sensor around (specifically adjacent to) the vicinity sensor which is one of the acceleration sensors 20 to 22 closest to a collision position of the vehicle. In other words, the pedestrian detection system determines whether the object colliding with the vehicle V is the pedestrian, based on a signal which changes by time differently according to whether or not the colliding object is the pedestrian. The pedestrian detection system therefore has an advantage in accuracy of determining whether or not the object colliding with the vehicle V is the pedestrian, and therefore suppresses an occurrence of a trouble caused by erroneously determining that the pedestrian has collided with the vehicle V.

The adjacent sensor outputs the signal indicating a sufficiently intensive acceleration because the adjacent sensor is located not too far from the collision position and the acceleration is not damped too much. The signal outputted by the adjacent sensor therefore needs no amplification or a small amount of amplification.

In addition, the calculation unit roughly determines, based on comparison of the signals outputted by the multiple acceleration sensors 20, 21 and 22, a collision position with which the object has collided. The pedestrian detection system therefore does not need a supplemental sensor dedicated to the determination of the collision position. The manufacturing cost of the pedestrian detection system therefore is suppressed. In addition, the collision position is easily detected by comparing the signals from the acceleration sensors 20, 21 and 22 with each other.

(Second Embodiment)

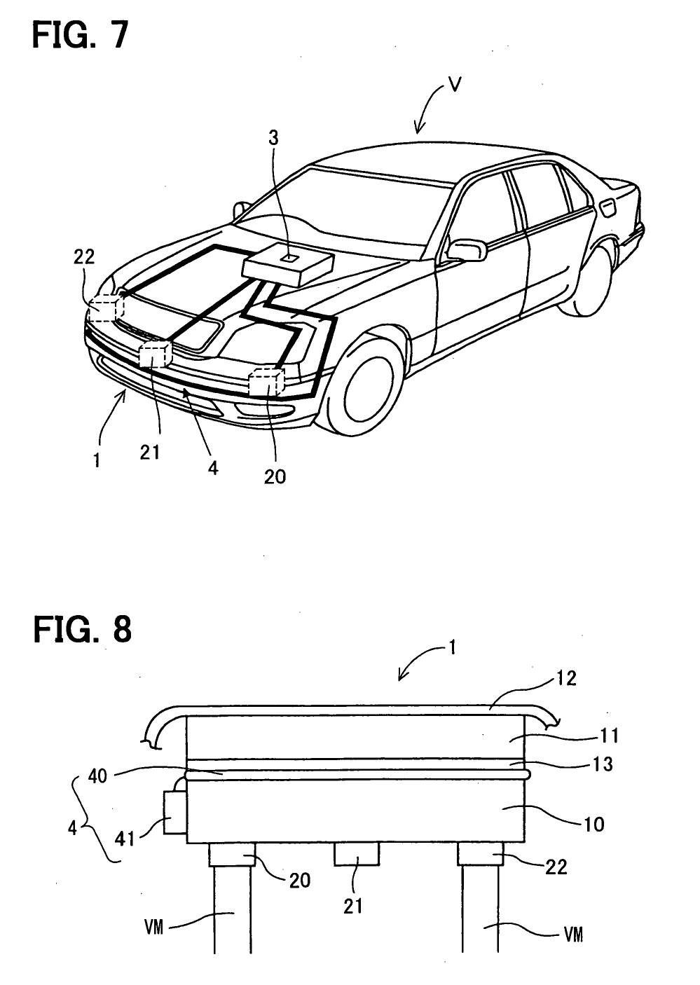

A pedestrian detection system according to the second embodiment is mainly different from that of the first embodiment in that the pedestrian detection system of the second embodiment further includes, as shown in FIG. 7, a touch sensor which is installed in the bumper 1 and detects a touch to the bumper 1.

The touch sensor 4 includes, as shown in FIG. 8, a sensing portion 40 and a detecting portion 41. The sensing portion 40 is made of conductive rubber having a shape of a strip band and is attached to the bumper 1 while being extended and arranged with its width direction along the bumper 1. The detecting portion 41 detects a change of conductivity of the sensing portion 40 by detecting specific resistance of the sensing portion 40. The touch sensor 4 is thus capable of detecting a position on the sensing portion 40 to which a pressure is applied.

More specifically, the sensing portion 40 of the touch sensor 4 is attached to the front face of the bumper reinforcement 10. A load plate 13 having a plate-like shape is attached to a front face of the sensing portion 40. The absorber 11 and the bumper cover 12 are located at a front side of the load plate 13.

The pedestrian detection system detects by using the touch sensor 4 the collision portion with which the object collides on the bumper 1. Then the pedestrian detection system determines whether the pedestrian has collided with the vehicle V in the same manner in the first embodiment.

As described above, the pedestrian detection system of the second embodiment is mainly different from that of the first embodiment in that the pedestrian detection system of the first embodiment detects a colliding position at which the object collides. Therefore, the pedestrian detection system can detect the collision portion more accurately than that of the first embodiment.

In addition, the pedestrian detection system may start detecting with the acceleration sensors 20, 21 and 22 the time variation of the acceleration with a time, after the calculation unit 3 receives a signal from the touch sensor 4.

Thus, the pedestrian detection system of the second embodiment can activate the acceleration sensors 20, 21 and 22 after the calculation unit 3 determines that a contact is made to the bumper 1. It is therefore unnecessary to keep the acceleration sensors 20, 21 and 22 always in active. In addition, it is possible to avoid an erroneous detection of a collision caused by a noise generated between the acceleration sensors 20 to 22 and the calculation unit 3. Moreover, inexpensive sensors which are capable of detecting a collision only at a small area around them can serve as the acceleration sensors 20, 21 and 22, because the acceleration sensors 20, 21 and 22 do not have to detect the collision portion.

(Third Embodiment)

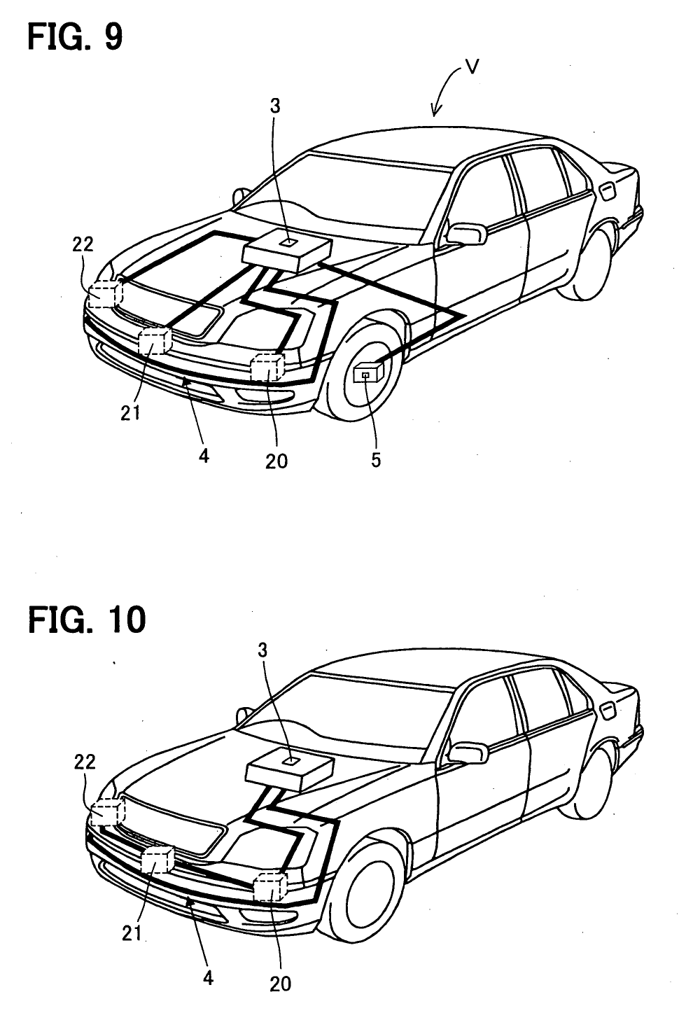

A pedestrian detection system according to the third embodiment is mainly different from that of the second embodiment in that the vehicle V further includes, as shown in FIG. 9, a vehicle speed sensor 5.

The vehicle speed sensor 5 is electrically connected with the calculation unit 3. The calculation unit 3 is thus capable of making calculations based on a speed of the vehicle V. Specifically, the calculation unit 3 can determine at the step 160 in FIG. 3 the threshold ΔVth based on the speed of the vehicle V. The pedestrian detection system can thus detect with a higher accuracy that the pedestrian collides with the vehicle V.

(Fourth Embodiment)

A pedestrian detection system according to the fourth embodiment is mainly different from that of the second embodiment in that the acceleration sensors 20, 21 and 22 are, as shown in FIG. 10, serially connected with the calculation unit 3.

The pedestrian detection system of the fourth embodiment needs less wire harnesses because it is not necessary to connect every acceleration sensor 20, 21 and 22 directly with the calculation unit 3. Thus, the pedestrian detection system of the fourth embodiment has an advantage in easiness in installing it to the vehicle V.

(Fifth Embodiment)

The fifth embodiment will be now described with reference to FIGS. 1, 11 and 12.

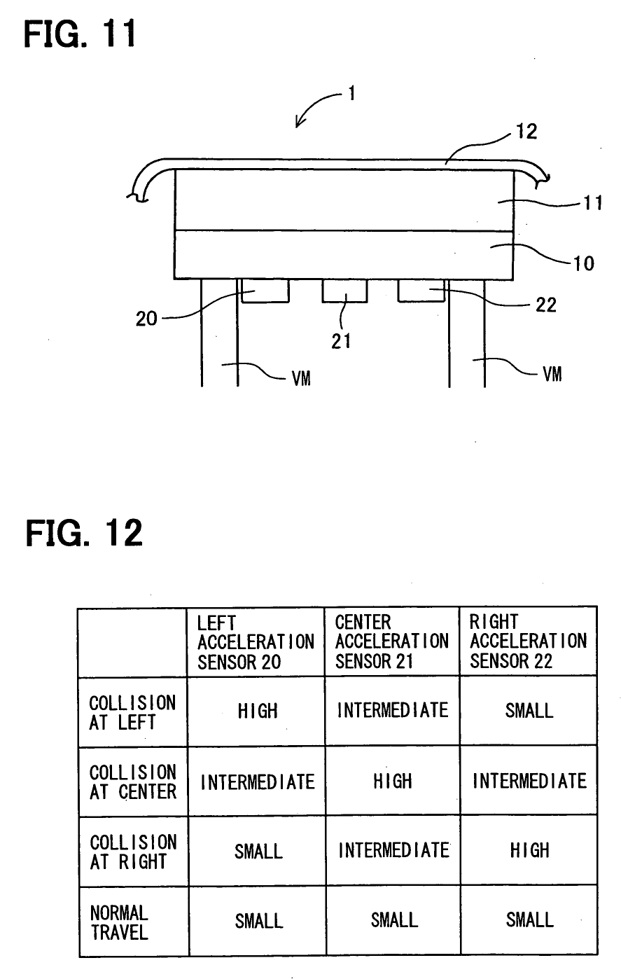

Similarly to the above-described first embodiment, a pedestrian detection system of the fifth embodiment includes, as shown in FIG. 1, a calculation unit 3 and acceleration sensors 20, 21 and 22. The acceleration sensors 20, 21 and 22 are attached to a bumper 1 of the vehicle V as shown in FIG. 11.

The vehicle V includes an engine room E in front of a passenger compartment of the vehicle V. However, the vehicle V, in which the pedestrian detection system is installed, is not limited to include the engine room E, and may be any kind of vehicle having the bumper 1.

As shown in FIG. 11, the bumper 1 in front of the engine room E includes a bumper reinforcement 10, an absorber 11 located at a front side of the bumper reinforcement 10, and a bumper cover 12 at a front side of the absorber 11. The bumper reinforcement 10 is fixed to the vehicle V through front side members VM located at a front left corner and a front right corner of the vehicle V. The absorber 11 is made of an elastic material such as resin foam and reduces an impact to be applied to a front side of the bumper reinforcement 10.

The acceleration sensors 20, 21 and 22 are attached at different portions to a rear side of the bumper reinforcement 10, so that the acceleration sensors 20, 21, and 22 can detect accelerations in the front-rear direction of the vehicle V.

More specifically, the acceleration sensor 21 is located at a center portion in the width direction of the bumper reinforcement 10. Each of the acceleration sensors 20 and 22 is located at a position which is slightly shifted to the center portion from a position of one of the front side members VM. In other words, each of the acceleration sensors 20, 21 and 22 is located between the front side members VM in the vehicle width direction.

The calculation unit 3 is electrically connected with the acceleration sensors 20, 21 and 22 in parallel, and performs a determination regarding a collision based on signals from the acceleration sensors 20, 21 and 22.

The calculation unit 3 is constructed as a single member together with an ECU which controls an air bag and thereby serves as an occupant protection unit. The calculation unit 3 operates as a pedestrian protection part for protecting a pedestrian when it performs a determination that the pedestrian has collided with the vehicle V.

Hereafter, a description will be given of an operation of the pedestrian detection system including the determination related to the collision in the case that an object collides with the vehicle V.

When an object collides with the bumper 1 of the running vehicle V, the bumper 1 receives acceleration in a direction toward the rear side of the vehicle V. The acceleration sensors 20, 21 and 22 detect a variation in the acceleration and output signals depending on the detected variation. The calculation unit 3 determines, by comparing the three signals from the acceleration sensors 20, 21 and 22 with date of a predetermined determination map shown in FIG. 12, a collision position of the bumper 1 with which the object has collided.

More specifically, the calculation unit 3 compares a first threshold with an intensity level of each of the three signals from the acceleration sensors 20, 21 and 22. When the intensity level is lower than the first threshold, the calculation unit 3 determines that the intensity level is “low”. When the intensity level is higher than the first threshold, the calculation unit 3 subsequently compares the intensity level with a second threshold which is higher than the first threshold. When the intensity level is lower than the second threshold, the calculation unit 3 determines that the intensity level is “intermediate”. When the intensity level is higher than the second threshold, the calculation unit 3 determines that the intensity level is “high”.

The acceleration sensors 20, 21 and 22 also detect the acceleration of the vehicle V while the vehicle V is traveling in a normal situation. The first threshold is set to a level so that the calculation unit 3 determines that the intensity levels received from the acceleration sensors 20, 21 and 22 are “small” as long as the vehicle V is traveling in a normal situation. The calculation unit 3 thus can determine whether or not the vehicle V is traveling in a normal situation.

The calculation unit 3 then determines the collision position of the bumper 1 based on the determination map and the results of determinations for the intensity levels of the signals from the acceleration sensors 20, 21 and 22. For example, when the intensity levels of the signals from the acceleration sensors 20 (left), 21 (center) and 22 (right) are “low”, “intermediate” and “high”, respectively, the calculation unit 3 determines that the collision position is at the right portion of the bumper 1.

The calculation unit 3 subsequently executes determinations whether an object colliding with the vehicle V is a pedestrian as described in the first embodiment and shown in FIG. 3. Thus the pedestrian detection system of the fifth embodiment has a beneficial effect similar to that of the pedestrian detection system of the first embodiment.

The pedestrian detection system of the fifth embodiment detects the collision position by using the determination map and the intensity levels of the three signals from the acceleration sensors 20, 21 and 22. In other words, the pedestrian detection system performs comparison of the first to third thresholds with each of signals outputted by the acceleration sensors 20, 21 and 22, and determines distances from the collision position to each of the acceleration sensors 20, 21 and 22. Then, the pedestrian detection system detects the collision position based on the determined distances. In addition, the sensors 20, 21 and 22 used for determining whether the collided object is a pedestrian are also used for determining the collision position. The pedestrian detection system therefore does not need a supplemental sensor dedicated to the determination of the collision position. The manufacturing cost of the pedestrian detection system therefore is suppressed.

In addition, the acceleration sensors 20, 21 and 22 are located between the front side members VM. If an object collides with the bumper 1 in which the bumper reinforcement 10 is fixed to the front side members VM, impact of the collision propagates not only through the bumper reinforcement 10 but also through the front side members VM. More specifically, the impact (force) propagating through the bumper reinforcement 10 significantly decays when it goes across a portion where the bumper reinforcement 10 and one of the front side members VM. In this embodiment, however, the acceleration sensors 20, 21 and 22 are located between the front side members VM. Accordingly, the impact of the collision is propagated from the acceleration sensor 20 to the acceleration sensor 22 without dissipation caused by the front side members VM. In other words, the front side members VM do not cause error when the calculation unit 3 determines the collision position. Thus the pedestrian detection system can detect the collision position with high accuracy.

As described in the above embodiments, the pedestrian detection system of the present invention has multiple acceleration sensors and a calculation unit.

The acceleration sensors are installed at different points in a periphery portion of a vehicle and detect changes of accelerations (deceleration) caused by a collision of an object with the vehicle. Variations of the accelerations by time depend mainly on a variation state of deceleration of the vehicle. The periphery portion of the vehicle is a portion at which the acceleration sensors can detect an impact of the collision. In this sense, locations of the acceleration sensors are not limited to places on an outer surface of the vehicle. The acceleration sensors may detect accelerations in any direction such as an anteroposterior direction or a lateral direction. A direction in which the acceleration sensors can detect the accelerations can be adjusted by changing orientations or detection characteristics of the acceleration sensors.

The calculation unit performs, based on signals from the acceleration sensors, a determination to classify the object colliding with the vehicle. For example, the calculation unit can determine that a pedestrian has collided with the vehicle when one of the signals indicates acceleration larger than an acceleration threshold.

In addition, the pedestrian detection system of the present invention determines the colliding object based on one of the multiple acceleration sensors other than one which is closest to a collision point with which the colliding object has collided. The one acceleration sensor (hereafter referred to as the closest acceleration sensor) closest to the collision portion outputs a signal which does not change sensitively to a kind of the colliding object. In other words, a colliding object sensitivity of the signal from the closest acceleration sensor is small. It is therefore difficult to determine based on the signal from the closest acceleration sensor whether or not the colliding object is a human body. The pedestrian detection system may therefore tend to determine the colliding object incorrectly if it determines the colliding object based on the closest acceleration sensor.

In contrast, an acceleration sensor other than the closest acceleration sensor output signals which are relatively sensitive to a kind of the colliding object. In other words, a colliding object dependency of the signals from acceleration sensors other than the closest acceleration sensor is larger than that of the signals from the closest acceleration sensor. The pedestrian detection system of the present invention suppresses occurrences of incorrect classifications, by using a signal from an acceleration sensor other than the closest acceleration sensor to classify the colliding object.

The vehicle possibly collides with various kinds of objects having different hardness. For example, a standing pavement marker and a pylon are harder than a human body and therefore absorbs smaller fraction of the impact of the collision than the human body. In addition, a standing pavement marker and a pylon are generally lighter than a human body and therefore give a smaller impact to the vehicle than the human body. Therefore, it is expected that a time dependency of a signal outputted by any of the acceleration sensors detecting the collision of the human body is clearly different from that of a signal outputted by the acceleration sensor detecting the collision of an object other than a human body.

However, it may be difficult to determine based on the signal from the closest acceleration sensor whether or not the colliding object is a human body. In contrast, an acceleration sensor other than the closest acceleration sensor outputs signals which are relatively sensitive to the determination whether or not the colliding object is a human body. The pedestrian detection system of the present invention determines based on one of the relatively sensitive signals whether or not the colliding object is a human body.

It is presumed that the differences of output signals in accordance with the colliding objects are caused by specific characteristics of damping of the impact through the body of the bumper (in particular, a bumper reinforcement). The characteristics of the damping are presumed to depend on total stiffness of the body (including the bumper) of the vehicle and a dependence of stiffness on positions in the bumper.

The acceleration sensor used to determine whether or not the pedestrian has collided with the vehicle is not limited to, as described in the above embodiment, an acceleration sensor adjacent to the closest sensor (collision portion).

The pedestrian detection system may detect in any method a collision portion in the vehicle, with which the object has collided.

The touch sensor 4 described in the second embodiment can be a tape switch.

The number of the acceleration sensors may be more than three or less than three.

The calculation unit 3 in the above embodiments can be replaced with any other calculation unit which can determine according to the acceleration sensors whether or not the colliding object is the pedestrian. Any calculation device installed for another purpose in the vehicle can be used as the calculation unit.

A quantity, which is used in the calculation unit 3 at the step 170, for comparing with a threshold, is not limited to the deformation rate (i.e. a time integral of the deceleration). The calculation unit 3 may compare with the threshold a representative quantity (e.g., a maximum deceleration) of the deceleration other than the deformation rate. The calculation unit 3 may then determine that the colliding object is a pedestrian if the representative quantity of the deceleration is larger than the threshold.

The bumper 10 may be attached to the front side or the rear side of the vehicle V, facing the front side or the rear side. The bumper 10 therefore collides with the obstacle in the front-rear direction and the acceleration sensors 20, 21 and 22 can detect the acceleration in the front-rear direction.

Such changes and modifications are to be understood as being within the scope of the present invention as defined by the appended claims.

What is claimed is:

1. A pedestrian detection system for a vehicle, comprising:
multiple acceleration sensors provided at different positions in a periphery portion of the vehicle; and
a calculation unit for performing, mainly based on a signal outputted by a designation acceleration sensor belonging to the multiple acceleration sensors, a determination whether an object colliding with the vehicle is a pedestrian,
wherein the designation acceleration sensor is one of the multiple acceleration sensors other than a closest acceleration sensor which is closest of the multiple acceleration sensors to a collision portion with which the object has collided.

2. The pedestrian detection system according to claim 1, wherein the designation acceleration sensor is one of the multiple acceleration sensors adjacent to the closest acceleration sensor.

3. The pedestrian detection system according to claim 1, wherein the calculation unit detects the collision portion based on comparison between signals outputted from the multiple acceleration sensors.

4. The pedestrian detection system according to claim 1, further comprising a touch sensor that is installed in the periphery portion, wherein the calculation unit detects the collision portion using a signal from the touch sensor.

5. The pedestrian detection system according to claim 1, wherein the multiple acceleration sensors are provided at a center portion and two end portions of a bumper of the vehicle.

6. The pedestrian detection system according to claim 1, wherein the calculation unit performs by using a speed of the vehicle, the determination whether the object colliding with the vehicle is the pedestrian.

7. The pedestrian detection system according to claim 1, wherein the calculation unit determines that the object colliding with the vehicle is the pedestrian, when a representative quantity of deceleration detected by the designation sensor is larger than a threshold.

8. The pedestrian detection system according to claim 7, wherein the calculation unit changes the threshold based on a speed of the vehicle.

9. The pedestrian detection system according to claim 7, wherein the representative quantity is a time integral of the deceleration detected by the designation sensor.

10. The pedestrian detection system according to claim 1, wherein the calculation unit detects the collision portion based on comparison of a threshold with each of signals outputted by the multiple acceleration sensors.

11. The pedestrian detection system according to claim 1, wherein:
the vehicle includes a bumper having a reinforcement and a pair of side members, the reinforcement extending in a width direction of the vehicle, the side members being attached to respective end portions of the reinforcement, the side members supporting the reinforcement; and
the acceleration sensors are attached to a center portion of the reinforcement in the width direction and a position between the center portion and at least one of the side members.
